(19) United States
(12) Patent Application Publication
(10) Pub. No.: US 2026/0056408 A1
(43) Pub. Date: Feb. 26, 2026

(54) OPTICAL ELEMENT IN-PLANE DISPLAY SYSTEM

(71) Applicant: VISTEON GLOBAL TECHNOLOGIES, INC., Van Buren Township, MI (US)

(72) Inventors: Pawel Murzyn, Chelmsford (GB); Paul Fredrick Luther Weindorf, Novi, MI (US); Brian John Hayden, Royal Oak, MI (US); James Arthur Carpenter, Eagle, MI (US)

(73) Assignee: VISTEON GLOBAL TECHNOLOGIES, INC., Van Buren Township, MI (US)

(21) Appl. No.: 19/308,761

(22) Filed: Aug. 25, 2025

Related U.S. Application Data
(60) Provisional application No. 63/686,318, filed on Aug. 23, 2024.

(51) Int. Cl. G02B 27/01; G02B 27/00

(52) U.S. Cl. CPC G02B 27/0103; G02B 27/0093; G02B 2027/0118; G02B 2027/0138; G02B 2027/0194

(57) ABSTRACT

An in-plane display system includes a projector, a multilayer film, and a driver monitoring system. The projector is operational to project a display light to an image plane. The multilayer film is disposed at the image plane and is operational to redirect the display light toward an eye box of a user. The multilayer film includes one of a holographic optical element or a diffraction optical element, an opaque filter, and an infrared reflector. The driver monitoring system is operational to monitor the user based on infrared light received from the infrared reflector.

### CROSS-REFERENCE TO RELATED APPLICATIONS

This application claims the benefit of U.S. Provisional Application No. 63/686,318, filed Aug. 23, 2024, which is hereby incorporated by reference in its entirety.

### TECHNICAL FIELD

The present disclosure generally relates to systems and methods for vehicle heads-up displays.

### BACKGROUND

Standard automotive heads-up displays provide specularly reflected display images to a driver. However, specular reflection laws are followed hindering freedom in a location of the image sources and viewing headboxes.

Accordingly, those skilled in the art continue with research and development efforts in the field of heads-up displays suitable for use with driver monitoring systems.

### SUMMARY

An in-plane display system is provided herein. The in-plane display system includes a projector, a multilayer film, and a driver monitoring system. The projector is operational to project a display light to an image plane. The multilayer film is disposed at the image plane and is operational to redirect the display light toward an eye box of a user. The multilayer film includes one of a holographic optical element or a diffraction optical element, an opaque filter, and an infrared reflector. The driver monitoring system is operational to monitor the user based on infrared light received from the infrared reflector.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 illustrates a context of a vehicle.

FIG. 2 illustrates a holographic diffuser film operational principle of an example HUD system.

FIG. 3 illustrates a standard HUD arrangement.

FIG. 4 illustrates a panoramic HUD (PHUD) arrangement.

FIG. 5 illustrates a holographic diffuser HUD (HDHUD) arrangement.

FIG. 6 illustrates recording and read out of transmitting and reflective optical elements.

FIG. 7 illustrates a lithography process used to manufacture a diffractive optical element.

FIG. 8 illustrates a graph of an infrared transmissive filter optical characteristics.

FIG. 9 illustrates a diagram of an in-plane diffuser HOE/DOE system with the opaque filter and the DMS system.

FIG. 10 illustrates a pillar-to-pillar HOE/DOE in-plane system.

FIG. 11 illustrates a top view of an implementation where multiple projectors may shine on the same image area to present different images.

FIG. 12 illustrates a side view of the implementation where multiple projectors may shine on the same image area to present different images.

FIG. 13 illustrates a graph of a Burnette Visual relationship.

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

### DETAILED DESCRIPTION

Embodiments of the disclosure generally provide for a heads-up display (HUD) system suitable for use with an infrared (IR) driver monitoring system (DMS). The system may be implemented as a panoramic display or a floating heads-up display. A multilayer film in the system may be mounted on or near a windshield of a vehicle 90. The multilayer film generally includes a diffractive element, a opaque filter, and an infrared reflector. An infrared (DMS) camera may be positioned to sense the infrared light. The sensed infrared light creates an infrared image used by the driver monitoring system. An ambient light sensor is used to adjust the HUD system to account for changing light conditions.

The disclosure generally provides a display based on an opaque or semi-opaque holographic (HOE) or diffractive (DOE) optical element. These in-plane diffusive type films act like a projection screen with very angular and wavelength specific reflective characteristics. Instead of using specularly reflected display images, the HOE/DOE diffuser PHUD (HDHUD) uses a holographic/diffractive diffuser film on an opaque background to diffract the projection source image to a viewing headbox whereby the specular reflection laws may not be followed thereby allowing unhindered freedom in the location of the projection sources and the viewing headboxes. An additional benefit of precise viewing headbox control is the minimization of the projector power and associated size. This technology operates in an automotive space that has not been previously explored and offers opportunities in the arenas of cost, power, and size for a cross cockpit display image at the bottom edge of the wind shield. The technology may be utilized in a host of different locations such as side window displays.

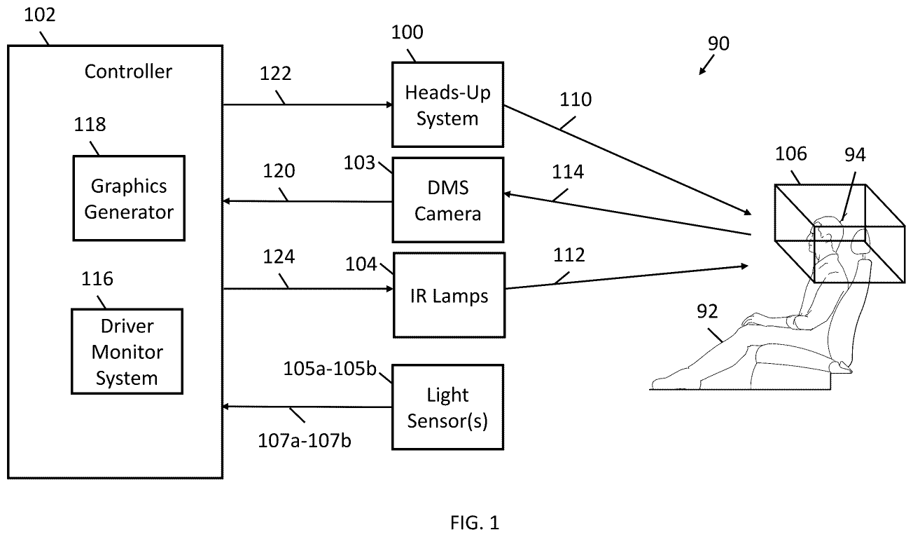

FIG. 1 illustrates a context of a vehicle 90. The vehicle 90 may house a user 92 (or person or driver). The vehicle 90 may include a heads-up display system 100, a controller 102, a DMS camera 103, one or more (one illustrated) infrared lamps 104, and one or more light sensors 105a-105b. An eye box 106 may be defined as a space around a head 94 of the user 92 in which the user 92 may view a visible image 110 generated and present by the heads-up source and redirected by the multilayer film. An illumination light 112 generated by the infrared lamp 104 may illuminate at least the head 94 of the user 92. The illumination light 112 reflected from the user 92 may be returned to the DMS camera 103 as an infrared image 114. The controller 102 may include a driver monitoring system (DMS) 116 and a graphics generator 118. The driver monitoring system 116 may receive an IR signal 120 from the DMS camera 103. The IR signal 120 may be representative of the infrared image 114 detected by the DMS camera 103. The graphics generator 118 generally presents a visible (VIS) signal 122 to the HUD system 100. The VIS signal 122 provides data used by the HUD system 100 to generate the visible images 110. An IR control signal 124 is generated by the controller 102 and received by the IR lamps 104. The IR control signal 124 controls a brightness of the illumination light 112.

The vehicle 90 may include mobile vehicles such as automobiles, trucks, motorcycles, boats, trains and/or aircraft. Other types of vehicles may be implemented to meet the design criteria of a particular application.

The user 92 may be a driver or other occupant of the vehicle 90. The user 92 may be monitored by the driver monitoring system 116 through the infrared image 114 received by the DMS camera 103 through the eye box 106.

The HUD system 100 may implement a projector that generates useful information for the user 92 in the visible images 110 about the operating conditions of the vehicle 90. For example, the HUD system 100 may present instrumentation data (e.g., speed, tachometer, fuel, temperature, etc.) to the user 92. In some embodiments, the HUD system 100 may also provide video images (e.g., a rear-view camera video, a forward-view camera video, etc.) to the user 92. In other embodiments, the HUD system 100 may further provide alphanumeric information to the user 92.

The DMS camera 103 is operational to detect the infrared images 114 of the user 92 as received from the eye box 106. The IR signal 120 generated by the DMS camera 103 is representative of the infrared images 114.

The controller 102 may implement one or more electronic control units. The controller 102. The controller 102 is operational to generate the VIS signal 122 to determine the visible images 110 that the HUD system 100 provides to the user 92. The controller 102 is also operational to receive the IR signal 120 as input to the driver monitoring system 116.

The infrared lamp 104 implements a source of infrared light. The infrared lamp 104 is operational to generate the illumination light 112 in response to the IR control signal 124. The illumination light 112 illuminates the user 92 in the infrared wavelengths.

A forward looking light sensor 105a implements an optical sensor. The forward looking light sensor 105a is operational to sense a forward luminance level received in a forward looking light. The forward looking light may be received substantially along a direction toward the user 92. The forward luminance level is presented to the controller 102.

An ambient light sensor 105b implements another optical sensor. The ambient light sensor 105b is operational to sense an ambient luminance level received in the ambient light. The ambient light may be received along a direction substantially toward the multilayer film of the HUD system 100. The ambient luminance level is presented to the controller 102. The forward luminance level and the ambient luminance level are used by the controller 102 to adjust a brightness (or visibility) of the images 110 presented to the user 92 to account for external light sources (e.g., the sun) entering the vehicle 90 and internal light within the vehicle 90.

The eye box 106 is a three-dimensional region in which the user 92 of the heads-up display 100 may see the visible images regardless of a current location and/or orientation of the head 94 of the user 92. In various embodiments, the eye box 106 may define a position of the driver's eyes is within a box of ±90 millimeters (mm) in width and ±50 mm in height. Other sizes of eye boxes 106 may be implemented to meet the design criteria of a particular application.

The driver monitoring system 116 is operational to monitor one or more conditions (e.g., alertness, eye direction, eyes open/closed, head orientation, etc.) of the user 92. The driver monitoring system 116 may generate a caution signal (e.g., physical, optical, acoustic and/or hepatic) upon determining that the user 92 is not alert and driving carefully.

The graphics generator 118 is operational to generate the VIS signal 122. The graphics generator 118 may receive data signals from a variety of sensors (not shown) in the vehicle 90. The sensor data is used to generate the graphics, numbers, symbols, etc. in the visible image produced by the HUD system 100.

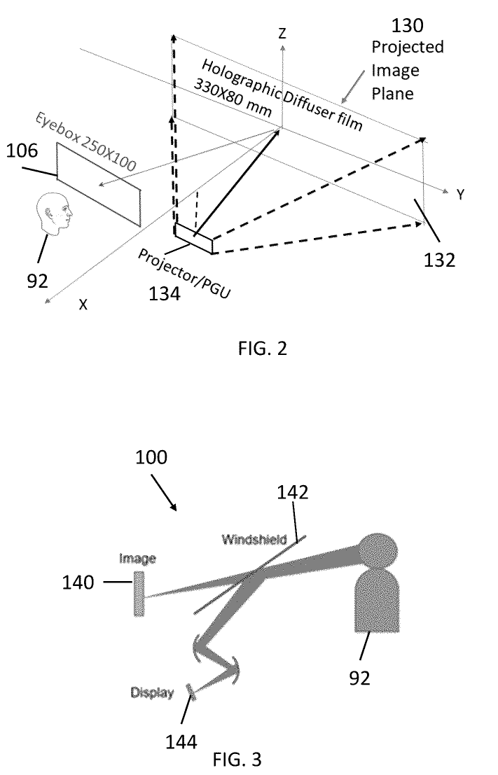

FIG. 2 illustrates a holographic diffuser film operational principle of an example HUD system.

Projected Image Plane 130—This image plane is what the user 92 sees at the location of the holographic diffuser film 132. The example in FIG. 2 shows that the viewer 92 will see an image size of approximately 330 millimeters (mm)×80 mm. The holographic diffuser film 132 may be clear but may be laminated to an opaque black background (or any background). The use of a black background significantly reduces the image luminance (e.g. 15,000 nits transparent to 1,000 nits black) suitable to view the images. Since the image appears at the multilayer film location, the method may be referred to as “in-plane” operation.

Eye box 106—The eye box 106 is the dimensional location for the eyes of the user 92 where the projected image is visible. Outside of the eye box 106, the image is not visible. The eye box 106 dimensions are different than the projected image size dimensions. The eye box 106 is not at the mirror specular reflection angle with respect to the projector to avoid ghost image reflections. A special feature of the holographic diffuser film 132 is that the projected image is only diffracted to the user eye box 106. The user eye box 106 may be any size, but as the eye box 106 size is increased, the projector output light power (lumens) may be increased to maintain the desired image luminance (cd/m² or nits).

Projector 134—The projector 134 may be located anywhere except at the mirror specular reflection angle with respect to the viewer 92. The black dotted arrows show the corners of the projected image on the holographic diffuser film 132.

FIG. 3 illustrates a standard HUD arrangement. In the standard HUD 100 arrangement, the image 140 appears to be out in front of the observer 92 by approximately 2-10 meters. To compete with the outside daylight ambient luminance, the image luminance values are high, on the order of 10,000 to 15,000 nits, that involves high display luminance values. The standard HUD 100 depends on the specular reflection (mirror angles) rate off of the windshield 142 and therefore uses a special “wedge” shaped wind shield 142 to eliminate the ghost image reflection. They also typically work with s-polarized light from the display 144 and are therefore difficult to see while using polarized sunglasses.

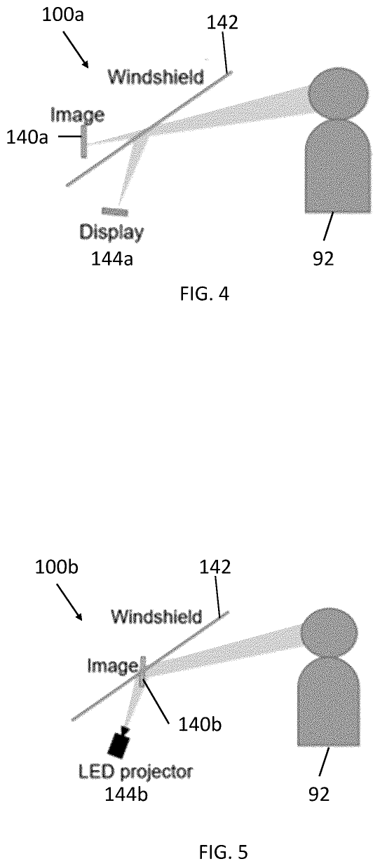

FIG. 4 illustrates a panoramic HUD (PHUD) arrangement. In the panoramic HUD (PHUD) 100a arrangement, the image 140a is simply a display directly reflected by some type of reflector element.

The panoramic HUD 100a is characterized by the direct reflection of a thin-film transistor (TFT) display 144a and the appearance of the image distance in front of the windshield 142 is equal to the distance from the windshield 142 to the display 144a (typically 10-15 centimeters). Normally weak reflective polarizers (20-30% reflection rate) are used on the reflection surface and therefore high TFT display luminance values on the order of 5,000 nits are used to get 1,000 nits for the image luminance. Weak reflective polarizers maintain the p-polarization from the display 144a to enable the display visibility while using polarized sunglasses. The PHUDs 100a are often characterized by a black opaque surface behind the reflective surface to increase the visibility of the image 140a due to the low luminance value. By using a weak reflective polarizer, the ghost image due to the front surface reflection may be eliminated for most wind shield rakes. Normally, unless a light control film (LCF) is utilized, all passengers will be able to see the display image 140a although windshield distortion compensation will only be seen by one of the users 92 (typically driver).

FIG. 5 illustrates a holographic diffuser HUD (HDHUD) 100b arrangement with an LED projector 144b to produce an image 140b. The holographic diffuser film appears to the user 92 as a classical projection screen. The holographic film is polarization independent, which absolves this technology from polarized sunglass visibility issues. Amongst all the advantages due to operating under the principle of diffraction, instead of specular reflection, an advantageous outcome is that the viewing angle may not be equal to the angle of incidence (AOI), which is a constraint for the other “reflective” based HUD technologies. Relief from the mirror reflection rule that subjugates other HUD technologies, offers the HDHUD 100b unfettered freedom for the viewer 92 and projection angle geometries. It also solves the ghost image problem which only occurs under mirror reflection geometries.

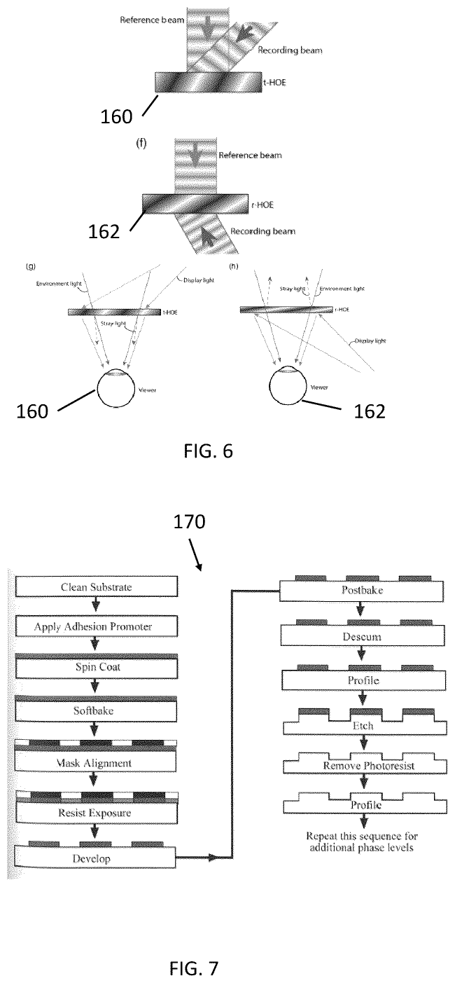

FIG. 6 illustrates recording and read out of transmitting 160 (t-HOE) and reflective 162 (r-HOE) optical elements. The technique for the opaque (black background) holographic diffuser HUD (HDHUD) grew from the advantages that may be offered:
Viewing angle is independent of projection angle of incidence (AOI) thereby allowing geometric freedom and elimination of ghost images.
The image eye box 106 may be tailored for constrained viewing angles (this offers not only the future capability of augmented reality (AR) which is seen only by the driver 92, but may be used for a complete active privacy (AP) solution for the passenger).
Polarization independent for use with polarized sunglasses.
A small projector may be utilized if the viewing eye boxes 106 are constrained to minimize the projector lumen output.
Offers a seamless display at the bottom of the windshield with no “gap” between displays as is seen in the PHUD solution.
May be used to display an image on any surface.
May be stacked so that that driver 92 and passenger may see different projection views in the same location.
Saturated colors since the diffracted bandwidths are very narrow leading better visibility due to the HK effect.
In the future, may be extended to provide floating images like an avatar in front of the holographic films.
The driver monitoring system (DMS) 116 (camera 103 and light source 104) may be incorporated into the design by using a specular reflector behind the DOE/HOE film 132 in conjunction with an opaque film or ink that is transmissive to IR wavelengths.

The use of a holographic or diffractive optical element diffusive film 132 is relatively new in the industry and are being explored in “clear” operational mode. Typically, the films 132 are embedded between two layers of glass in the windshield 142 to be used as a type of augmented reality (AR) HUD display. There are several suppliers for diffusive HOE films such as Zeiss, Ceres and Holoptic. There is at least one supplier for the diffusive diffractive optical element such as Photonic Crystal.

The holographic optical elements, similar to DOEs, rely on diffraction. A difference between the two is related to the creation process. Holographic elements use laser interference to record a phase grating in photosensitive material (e.g., reference and recording beam). Depending on a geometry of the interfering beams, transmission, reflection, or diffusive holograms may be created (see FIG. 6). To record the former, reference 164 and recording 166 beams are incident on the recording medium from the same side and grating vector is parallel to the surface of the film. A reflective hologram may be created with interfering beams illuminating the film from opposite sides, producing a pattern with a grating vector nearly perpendicular to the film surface.

The holographic optical elements are by nature much more wavelength selective than DOEs, with reflective volume holograms exhibiting particularly narrow spectral windows.

FIG. 7 illustrates a lithography process 170 used to manufacture a diffractive optical element. The DOEs may be designed to be less dependent on the wavelength of the light, relative to the HOEs. The DOEs may be designed using commercially available software. Recent progress allows to replicate the DOEs using a roll to roll processing, based on a lithographically created master.

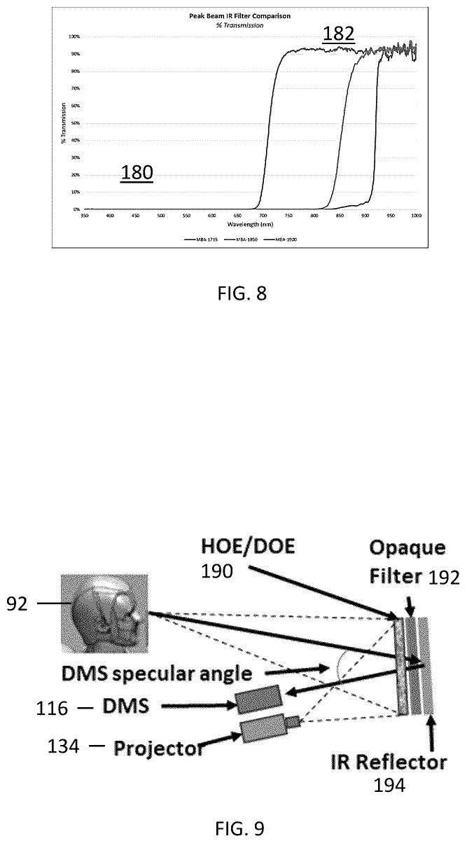

FIG. 8 illustrates a graph of an infrared transmissive filter optical characteristics. Instead of using the HOE/DOE films in the clear state, which generally requires around 15,000 nits of image luminance, an opaque, partially opaque, or adjustable opaque optical medium may be placed behind the diffusive in-plane HOE/DOE films. By using an opaque medium behind the in-plane film, the luminance criteria may be reduced from 15,000 nits to around 1,000 nits. By reducing the image luminance criteria, the projector source power and size may be reduced to easily fit within the available dashboard space in most vehicle applications. The projector may be of any type, including but not limited to digital light processing (DLP) projectors, micro light-emitting diode (uLED) projectors, liquid crystal on silicon (LCOS) projectors, or laser beam scanner (LBS) projectors.

An opaque, semi-opaque or adjustable neutral density filter may be used behind the HOE/DOE films to greatly reduce the picture generation unit (PGU) luminance criteria. The HOE or DOE films may be optically bonded to the opaque surface. Opaque inks may also be utilized behind the films and may be applied directly to the film or to the substrate to which the film is optically laminated. Generally, the best type of opaque surfaces would be closely index matched to the HOE/DOE film to reduce reflections from an optical interface for which the index of refractions are not well matched. The opaque type (including semi-opaque or adjustable type) may be of a design that transmits in the IR wavelengths such that the DMS camera and/or an IR emitter reflector may be employed behind the opaque filter. The IR filters may have transmission characteristics as shown in FIG. 8 where visible light 180 is absorbed, and the IR light 182 is transmitted.

The DMS reflector may be operated at the specular reflection angle which is compatible with the projector location that does not need to be at the specular reflection angle. An adjustable neutral density filter in the multilayer film may be controlled manually or automatically via the light sensor(s) 105a-105b. The filter may also be a static type whose transmission is not controlled.

FIG. 9 illustrates a diagram of an in-plane diffuser HOE/DOE system with the opaque filter and the DMS system.

The optical system may be as shown in FIG. 9, but may or may not include the use of a DMS system 116. If a DMS system 116 is not incorporated, the filter does not need to be IR transmissive and the rear substrate would not need to be reflective in the IR wavelengths. The HOE/DOE diffuser 190, filter 192 and DMS reflector 194 may be part of the windshield 142 or a separate unit in front of the windshield 142.

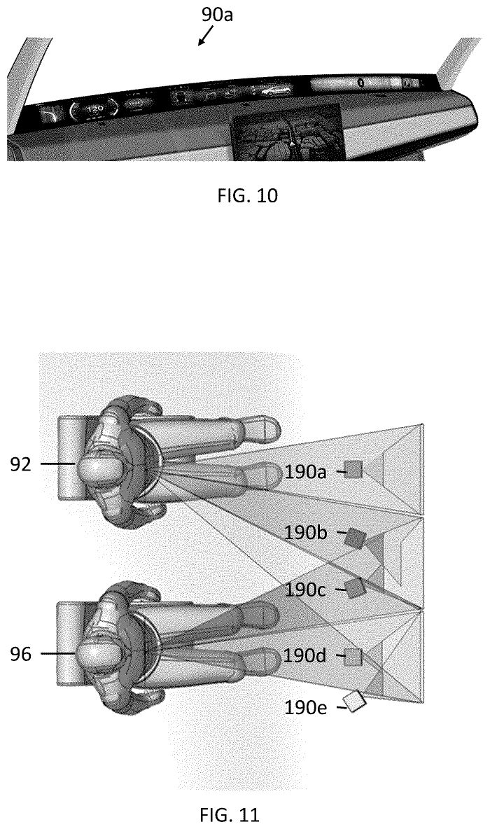

FIG. 10 illustrates a pillar-to-pillar HOE/DOE in-plane system 90a that has some of the following features:
Scalable (single zone or pillar to pillar).
Seamless display (no zone borders).
Integrate in the dashboard (de-coupled from the windshield).
Package space reduction compared to standard HUD solution (e.g., 10×).
Hidden DMS (seamless integration).
Enables dual view for both Driver and Passenger.

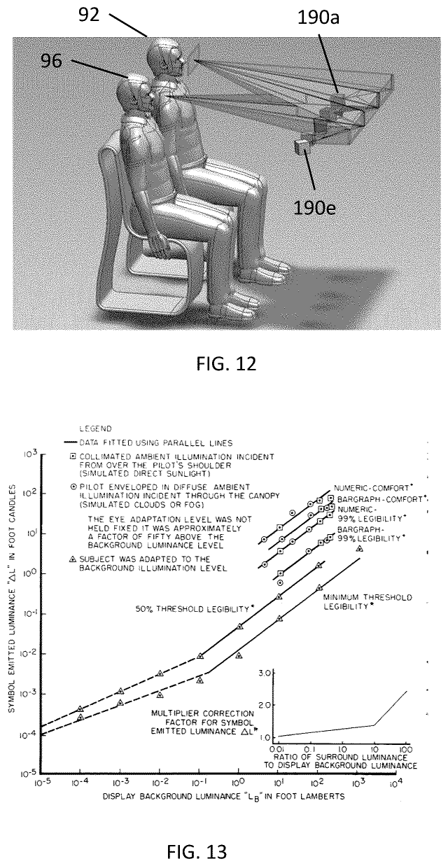

FIGS. 11 and 12 illustrate an example implementation where multiple projectors 190a-190e may shine on the same image area to present different images to the driver 92 and passenger 96. Due to the opaque nature of the implementation, the line of sight is below the regulatory criteria where the windshield 142 does not need to be clear. The adjustable neutral density filter may be static, controlled manually, or automatically controlled via a light sensor(s) 105a-105b.

FIG. 13 illustrates a graph of a Burnette Visual relationship. As an example, if the luminance looking out of the windshield is 5,000 nits, the user 92 (observer) would see 1,459 footlamberts (fL). If an image luminance of 1,000 nits is utilized, the observer would see 292 fL. Therefore, to see the display in the numeric comfort area, the background may be reduced from 1,459 fL to about 200 fL and therefore the transmission of the filter may be adjusted to about 13%. This example assumes there is little ambient reflected light from the multilayer film. A variable transmissive filter may be, but is not limited to, dichroic or dye doped liquid crystal based systems.

Those having ordinary skill in the art will recognize that terms such as “above,” “below,” “front,” “back,” “upward,” “downward,” “top,” “bottom,” etc., may be used descriptively herein without representing limitations on the scope of the disclosure. Furthermore, the present teachings may be described in terms of functional and/or logical block components and/or various processing steps. Such block components may be comprised of various hardware components, software components executing on hardware, and/or firmware components executing on hardware.

The foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. An in-plane display system comprising:
a projector operational to project a display light to an image plane;
a multilayer film disposed at the image plane and operational to redirect the display light toward an eye box of a user, wherein the multilayer film includes:
one of a holographic optical element or a diffraction optical element;
an opaque filter; and
an infrared reflector; and
a driver monitoring system operational to monitor the user based on infrared light received from the infrared reflector, wherein an image is formed at the image plane.

2. The virtual display system according to claim 1, wherein the multiplayer film is the holographic optical element.

3. The virtual display system according to claim 1, wherein the multiplayer film is the diffraction optical element.

4. The virtual display system according to claim 1, wherein the driver monitoring system includes an infrared camera operational to generate a plurality of infrared images of the user.

5. The virtual display system according to claim 1, further comprising:
an infrared lamp operational to illuminate the user.

6. The virtual display system according to claim 1, further comprising:
an ambient light sensor operational to measure an ambient luminance level, wherein
the projector is further operational to adjust a brightness of the display light in response to the ambient luminance level.

7. The virtual display system according to claim 6, further comprising:
a forward looking light sensor operational to measure a forward luminance level, wherein
the projector is further operational to adjust the brightness of the display light in further response to the forward luminance level.

8. The virtual display system according to claim 1, further comprising:
an additional projector operational to project an additional display light to the image plane;
an additional multilayer film disposed at the image plane and operational to redirect the additional display light toward the eye box of a user.

9. The virtual display system according to claim 1, wherein the image is formed at a windshield.

10. A method for in-plane display comprising:
projecting a display light with a projector to an image plane;
redirecting the display light with a multilayer film toward an eye box of a user, wherein the multilayer film is disposed at the image plane and includes:
one of a holographic optical element or a diffraction optical element;
an opaque filter; and
an infrared reflector; and
monitoring the user with a driver monitoring system based on infrared light received from the infrared reflector, wherein an image is formed at the image plane.

11. The method according to claim 10, wherein the multiplayer film is the holographic optical element.

12. The method according to claim 10, wherein the multiplayer film is the diffraction optical element.

13. The method according to claim 10, further comprising:
generating a plurality of infrared images of the user with an infrared camera operational of the driver monitoring system,

14. The method according to claim 10, further comprising:
illuminating the user with an infrared lamp.

15. The method according to claim 10, further comprising:
measuring an ambient luminance level with an ambient light sensor; and
adjusting a brightness of the display light projected by the projector in response to the ambient luminance level.

16. The method according to claim 15, further comprising:
measuring a forward luminance level with a forward looking light sensor; and
adjusting the brightness of the display light projected by the projector in further response to the forward luminance level.

17. The method according to claim 10, further comprising:
projecting an additional display light with an additional projector to the image plane; and
redirecting the additional display light toward the eye box of a user with an additional multilayer film disposed at the image plane.

18. The method according to claim 10, wherein the image is formed at a windshield.

19. A vehicle comprising:
a windshield; and
in-plane display system disposed between the windshield and a user, wherein the in-plane display system includes:
a projector operational to project a display light to an image plane;
a multilayer film disposed at the image plane and operational to redirect the display light toward an eye box of a user, wherein the multilayer film includes:
one of a holographic optical element or a diffraction optical element;
an opaque filter; and
an infrared reflector; and
a driver monitoring system operational to monitor the user based on infrared light received from the infrared reflector.

20. The vehicle according to claim 19, wherein the driver monitoring system includes an infrared camera operational to generate a plurality of infrared images of the user.
